(19) United States
(12) Patent Application Publication
(10) Pub. No.: US 2002/0125461 A1
(43) Pub. Date: Sep. 12, 2002

(54) Ammonium oxalate-containing polishing system and method

(75) Inventors: Homer Chou, Hoffman Estates, IL (US); Joseph D. Hawkins, Aurora, IL (US); Renjie Zhou, Aurora, IL (US)

Correspondence Address: PHYLLIS T. TURNER-BRIM, ESQ., LAW DEPARTMENT, CABOT MICROELECTRONICS CORPORATION, 870 NORTH COMMONS DRIVE, AURORA, IL, 60504, US

(73) Assignee: Cabot Microelectronics Corporation, Aurora, IL

(21) Appl. No.: 10/043,534

(22) Filed: Jan. 10, 2002

Related U.S. Application Data
(60) Provisional application No. 60/261,928, filed on Jan. 16, 2001.

(51) Int. Cl. C09K 13/02

(52) U.S. Cl. 252/79.1; 252/79.5

(57) ABSTRACT

The invention provides a polishing system and method for polishing or planarizing a substrate. The polishing system comprises (i) a liquid carrier, (ii) ammonium oxalate, (iii) a hydroxy coupling agent, and (iv) a polishing pad and/or an abrasive. The polishing method comprises contacting at least a portion of a substrate with the polishing system and polishing the portion of the substrate therewith.

### CROSS-REFERENCE TO RELATED PATENT APPLICATIONS

This patent application claims priority to provisional U.S. Patent Application No. 60/261,928 filed on Jan. 16, 2001.

### TECHNICAL FIELD OF THE INVENTION

The present invention provides a system and method for polishing or planarizing a substrate, especially a surface comprising a conductive metal.

### BACKGROUND OF THE INVENTION

Chemical-mechanical polishing (CMP) is a well-known process for planarizing the surfaces of substrates of microelectronic devices, such as semiconductor wafers. CMP typically involves applying a chemically reactive and mechanically abrasive polishing composition or “slurry” to the surface of a substrate. Polishing compositions generally are applied to the surface of a substrate by contacting the surface with a polishing pad saturated with the polishing composition. As the polishing composition chemically reacts with the substrate, the abrasive removes material from the surface of the substrate, thereby polishing the substrate. A more detailed explanation of chemical-mechanical polishing is set forth in U.S. Pat. Nos. 4,671,851, 4,910,155, and 4,944,836.

Because planar surfaces optimize the performance of semiconductor wafers, select surfaces of a semiconductor wafer must be polished without adversely affecting underlying structures or topology at a rapid rate and with high selectivity. Compositions that maximize removal rates and selectivity, therefore, are crucial to the efficient fabrication of microelectronic devices.

Although many CMP compositions and methods are known for improving removal rates and selectivity, such CMP compositions often utilize expensive and environmentally undesirable oxidizing agents. For example, the utilization of an oxidizing agent during the chemical-mechanical polishing of copper is described in U.S. Pat. No. 6,096,652.

Thus, there exists a need for other polishing systems and methods that improve removal rates and polishing selectivity, while minimizing surface defects and damage to underlying structures or topography, and that do not utilize an oxidizing agent. The invention is directed to providing such a polishing system and method. The advantages of the invention, as well as additional inventive features, will be apparent from the description of the invention provided herein.

### BRIEF SUMMARY OF THE INVENTION

The invention provides a polishing system and method for polishing or planarizing a substrate, desirably at a relatively high rate and selectivity. The polishing system comprises (i) a liquid carrier, (ii) ammonium oxalate, (iii) a hydroxy coupling agent, and (iv) a polishing pad and/or an abrasive. The polishing method comprises contacting at least a portion of a substrate with the polishing system and polishing the portion of the substrate therewith.

### DETAILED DESCRIPTION OF THE INVENTION

The invention is directed to a polishing system and method for polishing or planarizing a substrate. The polishing system comprises (a) a liquid carrier, (b) ammonium oxalate, (c) a hydroxy coupling agent, and (d) a polishing pad and/or an abrasive. The polishing system desirably consists essentially of or consists of (a) a liquid carrier, (b) ammonium oxalate, (c) a hydroxy coupling agent, and (d) a polishing pad and/or an abrasive, as well as optionally (e) a film-forming agent.

The liquid carrier can be any suitable carrier (e.g., solvent). Suitable liquid carriers include, for example, aqueous carriers (e.g., water) and nonaqueous carriers (e.g., organic liquids). The liquid carrier facilitates the application of other components of the polishing system (e.g., the ammonium oxalate, the hydroxy coupling agent, and, if present and suspended in the liquid carrier, the abrasive) onto the surface of the substrate. Preferably, the liquid carrier is water.

A polishing additive, specifically, ammonium oxalate is present in the polishing system in any suitable amount. Preferably, the ammonium oxalate is present in the liquid portion of the polishing system in an amount of about 0. 1-5 wt. %. More preferably, the ammonium oxalate is present in the liquid portion of the polishing system in an amount of about 0.5-1.5 wt. %. Most preferably, the ammonium oxalate is present in the liquid portion of the polishing system in an amount of about 0.5-2 wt. % (e.g., about 1 wt. %).

The hydroxy coupling agent can be any suitable hydroxy (—OH) coupling agent. Suitable hydroxy coupling agents, include, for example, coupling agents that can be used to reduce the surface hydroxyl density of metal oxide abrasives. Suitable hydroxy coupling agents that reduce the surface hydroxyl density of metal oxide abrasives include, for example, silane coupling agents, aluminum coupling agents, organotitanium coupling agents, and organophosphorous coupling agents.

The hydroxy coupling agent preferably is a silane-containing compound, such as a silane-containing compound that has the formula Y—Si—(X₁X₂R), wherein Y, R, X₁, and X₂ individually can be a non-hydrolyzable substituent or a hydrolyzable substituent such as, for example, a hydroxy substituent, so long as at least one of Y, R, X₁, and X₂ is a hydroxy-containing substituent such that the silane-containing compound is a hydroxy coupling agent. The silane-containing compound can be a dimer, trimer, or oligomer that can contain from about 4 to 15 siloxane units. The silane-containing compound more preferably has the formula Y—Si—(X₁X₂R), wherein Y is hydroxy or alkoxy (e.g., C₁-C₁₀ alkoxy), R is a non-hydrolyzable substituent, and X₁ and X₂ individually are hydrolyzable substituents or, most preferably, non-hydrolyzable substituents. The hydrolyzable substituents generally are those substituents that result in the formation of Si(OH) in an aqueous medium. Such hydrolyzable substituents include, for example, hydroxy, alkoxy (e.g., C₁-C₁₀ alkoxy), halogen such as chloride, carboxylate, and amide. The non-hydrolyzable substituents generally are those that do not result in the formation of Si(OH) in an aqueous medium. Such non-hydrolyzable substituents include, for example, alkyl (e.g., C₁-C₂₅ alkyl), alkene (e.g., C₂-C₂₅ alkene), and aryl (e.g., C₆-C₂₅ aryl), any of which can be in any configuration, functionalized, and substituted with any suitable atom, such as oxygen, nitrogen, sulfur, phosphorous, halogen, silicon, and combinations thereof. Preferably, the non-hydrolyzable substituent is a functionalized alkyl (e.g., a C₁-C₂₅ alkyl) selected from the group consisting of alkylnitrile, alkylamide, alkylcarboxylic acid, or alkyluriedo. The silane-containing compound most preferably has the formula Y—Si—(X₁X₂R), wherein Y, X₁, and X₂ individually are hydroxy or C₁-C₁₀ alkoxy, and R is a ureido(C₁-C₁₀)alkyl.

Suitable silane-containing hydroxy coupling agents include, for example, aminosilanes, ureidosilanes, alkoxysilanes, alkylsilanes, mercaptosilanes, vinylsilanes, cyanosilanes, thiocyanatosilanes, functionalized silanes, disilanes, trisilanes, and combinations thereof. Silanes with a single hydrolyzable substituent include, for example, cyanopropyldimethylalkoxysilane, N,N′-(alkoxymethylsilylene)bis[N-methyl-benzamide], chloromethyldimethylalkoxysilane, and mixtures thereof. Silanes with two hydrolyzable substituents include, for example, chloropropyl methyldialkoxysilane, 1,2-ethanediylbis[alkoxydimethyl] silane, dialkoxymethylphenyl silane, and mixtures thereof Suitable silanes with three hydrolyzable substituents include, for example, glycidoxypropyltrialkoxysilane, isocyanatopropyltrialkoxysilane, ureidopropyltrialkoxysilane, mercaptopropyltrialkoxysilane, cyanoethyltrialkoxysilane, 4,5-dihydro-1-(3-trialkoxysilylpropyl)imidazole, 3-(trialkoxysilyl)-methyl ester propanoic acid, trialkoxy[3-(oxiranylalkoxy)propyl]-silane, 2-methyl, 3-(trialkoxysilyl)propyl ester 2-propenoic acid, [3-(trialkoxysilyl)propyl] urea, and mixtures thereof. Most preferably, the hydroxy coupling agent is ureidopropyltrimethoxysilane, especially gamma-ureidopropyltrimethoxysilane.

The hydroxy coupling agent is present in the polishing system in any suitable amount. Preferably, the hydroxy coupling agent is present in the liquid portion of the polishing system in an amount of about 0.01-1 wt. %. More preferably, the hydroxy-coupling agent is present in the liquid portion of the polishing system in an amount of about 0.01-0.1 wt. %.

Any suitable polishing pad can be used in the polishing system. The polishing pad can be any suitable abrasive or non-abrasive pad. Moreover, the polishing system can comprise a polishing pad (either an abrasive pad or a non-abrasive pad), wherein either an abrasive is suspended in the liquid portion of the polishing system or no abrasive is suspended in the liquid portion of the polishing system. Suitable polishing pads are described, for example, in U.S. Pat. Nos. 5,849,051 and 5,849,052. Suitable polishing pads include, for example, woven and non-woven polishing pads. Moreover, suitable polishing pads can comprise any suitable polymer of varying density, hardness, thickness, compressibility, ability to rebound upon compression, and compression modulus. Suitable polymers include, for example, polyvinylchlorides, polyvinylfluorides, nylons, fluorocarbons, polycarbonates, polyesters, polyacrylates, polyethers, polyethylenes, polyurethanes, polystyrenes, polypropylenes, polymelamines, polyamides, polyvinyl acetates, polyacrylic acids, polyacrylamides, polysulfones, and coformed products thereof, and mixtures thereof. When an abrasive is fixed (e.g., embedded), in whole or in part, in or on the polishing pad of the polishing system, such fixation on the polishing pad can be accomplished in any suitable manner.

The polishing system can comprise any suitable abrasive. The abrasive can be suspended in the liquid carrier (e.g., water) of the polishing system, thereby being a part of the liquid portion of the polishing system. The abrasive of the polishing system can be fixed (e.g., embedded), in whole or in part, in or on a polishing pad (e.g. polishing surface).

The abrasive of the polishing system can be any suitable abrasive. The abrasive can be heat-treated and/or chemically-treated (e.g., an abrasive with chemically-linked organic functional groups). Suitable abrasives include, for example, metal oxides. Suitable metal oxides include, for example, alumina, silica, titania, ceria, zirconia, germania, magnesia, and coformed products thereof, and mixtures thereof. The metal oxides can be fumed (i.e., pyrogenic), precipitated, condensation-polymerized, or colloidal in nature. For example, the metal oxides can be as described in U.S. Pat. No. 5,230,833 or the commercially available Akzo-Nobel Bindzil 50/80 or Nalco 1050, 2327, or 2329 metal oxide particles, as well as other similar products available from DuPont, Bayer, Applied Research, Nissan Chemical, and Clariant. The abrasive of the polishing system preferably is a fumed metal oxide. More preferably, the abrasive is fumed silica.

The abrasive can be present in the polishing system in any suitable amount. For example, the abrasive can be present in the liquid portion of the polishing system in an amount of about 0.1-20 wt. %. Preferably, the abrasive is present in the liquid portion of the polishing system in an amount of about 0.1-10 wt. %. More preferably, the abrasive is present in the liquid portion of the polishing system in an amount of about 0.1-1 wt. % (e.g., about 0.2-0.8 wt. %).

The polishing system optionally comprises a film-forming agent. The film-forming agent can be any suitable film-forming agent. Suitable film-forming agents include, for example, any compound, or mixture of compounds, that facilitates the formation of a passivation layer (i.e., a dissolution-inhibiting layer) on a metal layer and/or a metal oxide layer. Suitable film-forming agents include, for example, nitrogen-containing heterocyclic compounds. Preferably, the film-forming agent comprises one or more 5-6 member heterocyclic nitrogen-containing rings. More preferably, the film-forming agent is selected from the group consisting of 1,2,3-triazole, 1,2,4-triazole, benzotriazole, benzimidazole, benzothiazole, and derivatives thereof, such as, for example, hydroxy-, amino-, imino-, carboxy-, mercapto-, nitro-, urea-, thiourea-, or alkyl-substituted derivatives thereof. Most preferably, the film-forming agent is benzotriazole.

The film-forming agent can be present in the polishing system in any suitable amount. Preferably, the film-forming agent is present in the liquid portion of the polishing system in an amount of about 0.005-1 wt. %. More preferably, the film-forming agent is present in the liquid portion of the polishing system in an amount of about 0.01-0.2 wt. %.

The polishing system can have any suitable pH. The pH of the polishing system desirably is about 7-13. Preferably, the polishing system has a pH of about 8-12. More preferably, the pH of the polishing system is about 9-11.

Any suitable pH adjusting agent can be used to adjust the pH of the polishing system. Suitable pH adjusting agents include, for example, acids and bases. Typically, the polishing system will include a base, such as a hydroxide compound, e.g., potassium hydroxide, sodium hydroxide, ammonium hydroxide, lithium hydroxide, magnesium hydroxide, calcium hydroxide, or barium hydroxide, or an amine compound. The pH adjusting agent can be a mixture of compounds, such as a mixture of potassium hydroxide and lithium hydroxide. The pH adjusting agent can be in the form of a solution, e.g., an aqueous solution. An example of a metal hydroxide-containing solution that can be a pH adjusting agent is a solution of potassium hydroxide in deionized or distilled water in which the amount of potassium hydroxide is about 0.1-0.5 wt. % (e.g., about 0.2-0.3 wt. %). Preferably, the pH adjusting agent is potassium hydroxide.

Other components can be, but need not be, present in the polishing system. Such other components can be compounds that stabilize the polishing system or that improve or enhance the performance of the polishing system. For example, buffers can be present in the polishing system. Suitable buffers include carbonates (e.g., potassium carbonate), phosphates, and carboxylic acids. Desirably, the polishing system does not contain an oxidizing agent.

The polishing system preferably has a polishing selectivity of copper to tantalum (i.e., a Cu:Ta removal rate) of at least about 1:1, such as at least about 2:1. The polishing system preferably has a polishing selectivity of copper to tetraethoxysilane (TEOS) (i.e., a Cu:TEOS removal rate) of at least about 1:2.

The invention also provides a method of polishing or planarizing a substrate comprising contacting at least a portion of a substrate with the polishing system and polishing the portion of the substrate therewith. The polishing system can be used to polish any suitable substrate, especially one or more layers of a multi-layer substrate. Preferably, the polishing system is used to polish a multi-layer substrate that includes a first metal layer, a second layer, and optionally one or more additional layers. Suitable first metal layers include, for example, copper (Cu), aluminum (Al), aluminum copper (Al-Cu), aluminum silicon (Al-Si), titanium (Ti), titanium nitride (TiN), tungsten (W), tungsten nitride (WN), noble metals (e.g., iridium (Ir), ruthenium (Ru), gold (Au), silver (Ag), and platinum (Pt)), and combinations thereof. Suitable second layers include, for example, titanium (Ti), titanium nitride (TiN), tantalum (Ta), tantalum nitride (TaN), tungsten (W), tungsten nitride (WN), oxides (e.g., silicon dioxide), low-κ materials and dielectrics (e.g., porous silica, fluorine-doped glass, carbon-doped glass, and organic polymers), and combinations thereof. Most preferably, the substrate comprises a first metal layer of copper or a copper alloy (i.e., a combination of copper and one or more metals), an adhesive layer of tantalum (Ta) or tantalum nitride (TaN), and a layer of tetraethoxysilane (TEOS).

In addition to being suitable for polishing semiconductor wafers, the polishing system can be used to polish or planarize other substrates, such as prime silicon, rigid or memory disks, inter-layer dielectrics (ILDs), micro-electromechanical systems (MEMS), ferroelectrics, magnetic heads, noble metals, polymeric films, and low and high dielectric constant films.

### EXAMPLE

This example further illustrates the present invention but, of course, should not be construed as in any way limiting its scope. This example illustrates the improved performance that can be achieved through use of the polishing system and method of the invention, particularly to provide an increased copper removal rate in polishing a copper-containing multi-component substrate.

Nine polishing systems (A-I) were prepared, each of which contained about 0.6 wt. % fumed silica (Cabot's Cab-O-Sil®L-90 fumed silica), about 0.25 wt. % gamma-ureidopropyltrimethoxysilane, about 0.04 wt. % benzotriazole, about 0.03 wt. % potassium hydroxide, about 0.004 wt. % potassium carbonate, water, and either no polishing additive (polishing system A) or 1 wt. % of a polishing additive (polishing systems B-I). The polishing additive was different in each polishing system and was either tartaric acid (polishing system B), N-acetyl glycine (polishing system C), potassium oxalate (polishing system D), aminotri(methylenephosphonic acid) (polishing system E), ammonium sulfate (polishing system F), ammonium acetate (polishing system G), diammonium EDTA (polishing system H), or ammonium oxalate (polishing system I). Thus, this example involved a control polishing system (A), comparative polishing systems (B-I), and the polishing system of the invention (I). Each of these polishing systems was used to polish a similar semiconductor wafer comprising copper, tantalum, and TEOS under similar conditions. The rate at which the copper on the substrate was removed was determined for each polishing system.

The substrates were polished with the polishing systems on an IPEC 472 polishing device using a Rodel® IC1000 pad. The substrates were subjected to a downforce pressure of about 20 kPa (3 psi), a platen speed of 87 rpm, and a carrier speed of 93 rpm. The polishing systems were supplied to the polishing device at a rate of 180-200 ml/min for 60 sec. Following the use of the polishing systems, the removal rates of copper from the substrates were measured. The resulting data is set forth in the following table.

TABLE
Copper Removal Rates

| Polishing | | Copper Removal Rate |
|---|---|---|
| System | Polishing Additive | [Å/min] |
| A | none | 270 |
| B | tartaric acid | 291 |
| C | N-acetyl glycine | 263 |
| D | potassium oxalate | 227 |
| B | aminotri(methylenephosphonic acid) | 247 |
| F | ammonium sulfate | 234 |
| G | ammonium acetate | 227 |
| H | diammonium EDTA | 260 |
| I | ammonium oxalate | 673 |

As is apparent from the data set forth in the table, the polishing system of the invention (i.e., polishing system I) that contained ammonium oxalate achieved a much higher copper removal rate than the control and comparative polishing systems (i.e., polishing systems A-H) that did not contain ammonium oxalate but were otherwise similar to the polishing system of the invention. In particular, the utilization of ammonium oxalate in conjunction with a liquid carrier, a hydroxy coupling agent, and a polishing pad and/or an abrasive increased the copper removal rate by a factor of about 2-3, as compared to similar polishing systems that did not contain ammonium oxalate.

All of the references cited herein, including patents, patent applications, and publications, are hereby incorporated in their entireties by reference.

While this invention has been described with an emphasis upon preferred embodiments, variations of the preferred embodiments may be used, and it is intended that the invention may be practiced otherwise than as specifically described herein. Accordingly, this invention includes all modifications encompassed within the spirit and scope of the invention as defined by the claims.

What is claimed is:

1. A system for polishing a substrate comprising (i) a liquid carrier, (ii) ammonium oxalate, (iii) a hydroxy coupling agent, and (iv) a polishing pad and/or an abrasive.

2. The polishing system of claim 1, wherein the liquid carrier is a nonaqueous solvent.

3. The polishing system of claim 1, wherein the liquid carrier is water.

4. The polishing system of claim 3, wherein no abrasive is present, and the polishing pad is a non-abrasive pad.

5. The polishing system of claim 3, wherein an abrasive is fixed on the polishing pad.

6. The polishing system of claim 3, wherein the polishing system comprises an abrasive suspended in the water.

7. The polishing system of claim 6, wherein the abrasive is a metal oxide.

8. The polishing system of claim 7, wherein the abrasive is silica.

9. The polishing system of claim 8, wherein the hydroxy coupling agent is ureidopropyltrimethoxysilane.

10. The polishing system of claim 9, further comprising a film-forming agent.

11. The polishing system of claim 10, wherein the film-forming agent is an organic heterocycle comprising at least one 5-6 member heterocyclic nitrogen-containing ring.

12. The polishing system of claim 11, wherein the film-forming agent is benzotriazole.

13. The polishing system of claim 3, wherein the hydroxy coupling agent is a silane-containing compound.

14. The polishing system of claim 13, wherein the hydroxy coupling agent is ureidopropyltrimethoxysilane.

15. The polishing system of claim 3, wherein the pH is about 9-11.

16. A method of polishing a substrate comprising contacting at least a portion of a substrate with the polishing system of claim 1 and polishing the portion of the substrate therewith.

17. The method of claim 16, wherein the substrate comprises copper.

18. The method of claim 17, wherein the substrate further comprises tantalum.

19. The method of claim 18, wherein the Cu:Ta removal rate is at least about 1:1.

20. The method of claim 17, wherein the substrate further comprises tetraethoxysilane.

21. The method of claim 20, wherein the Cu:TEOS removal rate is at least about 1:2.

22. A method of polishing a substrate comprising contacting at least a portion of a substrate with the polishing system of claim 12 and polishing the portion of the substrate therewith.

23. The method of claim 22, wherein the substrate comprises copper.

24. The method of claim 23, wherein the substrate further comprises tantalum.

25. The method of claim 24, wherein the Cu:Ta removal rate is at least about 1:1.

26. The method of claim 23, wherein the substrate further comprises tetraethoxysilane.

27. The method of claim 26, wherein the Cu:TEOS removal rate is at least about 1:2.
